(19) United States
(12) Patent Application Publication
(10) Pub. No.: US 2025/0200772 A1
(43) Pub. Date: Jun. 19, 2025

(54) IMAGE PROCESSING NETWORK MODULE, IMAGE PROCESSING DEVICE, AND METHOD OF OPERATING THE IMAGE PROCESSING DEVICE

(71) Applicant: SAMSUNG ELECTRONICS CO., LTD., Suwon-si (KR)

(72) Inventors: Youngil Seo, Suwon-si (KR); Taeshick Wang, Suwon-si (KR); Wonseok Lee, Suwon-si (KR); Jeongguk Lee, Suwon-si (KR); Dongpan Lim, Suwon-si (KR)

(73) Assignee: SAMSUNG ELECTRONICS CO., LTD., Suwon-si (KR)

(21) Appl. No.: 18/982,231

(22) Filed: Dec. 16, 2024

(30) Foreign Application Priority Data
Dec. 18, 2023 (JP) 10-2023-0185064
May 3, 2024 (JP) 10-2024-0059419

(51) Int. Cl. G06T 7/50

(52) U.S. Cl. CPC G06T 7/50; G06T 2207/20084

(57) ABSTRACT

An image processing network module, an image processing device, and a method of operating the image processing device are provided. The image processing network module includes an encoder configured to receive input image data and change a bit depth of the input image data to generate first image data, a quantization network configured to quantize the first image data to generate second image data, and a decoder configured to receive the second image data and change a bit depth of the second image data to generate output image data.

### CROSS-REFERENCE TO RELATED APPLICATION

This application is based on and claims priority under 35 U.S.C. § 119 to Korean Patent Application Nos. 10-2023-0185064, filed on Dec. 18, 2023 in the Korean Intellectual Property Office, and 10-2024-0059419, filed on May 3, 2024 in the Korean Intellectual Property Office, the disclosures of which are incorporated herein by reference in their entireties.

### BACKGROUND

One or more example embodiments of the disclosure relate to an electronic device, and more particularly, to an image processing network module using a neural network, an image processing device, and a method of operating the image processing device.

The neural network refers to a computational architecture that models a biological brain. With the recent development of neural network technology, research is being actively conducted to analyze input image data received from image sensors and to extract valid information from the analyzed input image data by using neural network devices in various types of electronic systems.

However, technology using deep learning has a problem of taking a long time to process data in mobile devices with low computational power due to a high amount of computations. In order to apply deep learning technology to mobile devices, a process of reducing processing time by reducing network complexity is required, but in the process, image quality may be degraded. Therefore, when deep learning technology is applied to mobile devices, technology of improving a quality of output image data while reducing the amount of computations required to process input image data in a neural network is required.

### SUMMARY

One or more example embodiments of the disclosure relate an image processing network module, an image processing device including the image processing network module, and a method of operating the image processing device, in which a bit depth of one or more bits selected from bits constituting input image data may be reduced by using a neural network, thereby reducing an amount of data processed while maintaining image characteristics of the input image data as much as possible. Accordingly, an area and a power consumption of the image processing network module may be reduced.

According to an aspect of an example embodiment of the disclosure, there is provided an image processing network module including an encoder configured to receive input image data and change a bit depth of the input image data to generate first image data, a quantization network configured to quantize the first image data to generate second image data, and a decoder configured to receive the second image data and change a bit depth of the second image data to generate output image data.

According to an aspect of an example embodiment of the disclosure, there is provided an image processing device including a camera module configured to receive an input image and a neural network processor configured to generate input image data by dividing the input image into blocks of a predetermined size and configured to generate output image data by performing image processing on the input image data by using a neural network model trained to perform preset image processing operations. The neural network processor includes an encoder configured to receive the input image data and change a bit depth of the input image data to generate first image data, a quantization network configured to quantize the first image data to generate second image data, and a decoder configured to receive the second image data and change a bit depth of the second image data to generate output image data.

According to an aspect of an example embodiment of the disclosure, there is provided an image processing operation method including receiving an input image, dividing the input image into blocks of a predetermined size to generate input image data, generating first image data by changing a bit depth of the input image data, quantizing the first image data to generate second image data, and generating output image data by changing a bit depth of the second image data.

### BRIEF DESCRIPTION OF DRAWINGS

Example embodiments will be more clearly understood from the following detailed description taken in conjunction with the accompanying drawings in which:

FIG. 1 is a block diagram illustrating a neural network system according to one or more example embodiments;

FIG. 2 is a diagram illustrating a structure of a neural network according to one or more example embodiments;

FIG. 3 is a block diagram illustrating an image processing network module according to one or more example embodiments;

FIG. 4 is a diagram illustrating input image data according to one or more example embodiments;

FIG. 5 is a diagram illustrating a bit truncating method according to one or more example embodiments;

FIG. 6 is a diagram illustrating a bit restoring method according to one or more example embodiments;

FIG. 7 is a flowchart illustrating a method of operating an image processing network module according to one or more example embodiments;

FIG. 8 is a block diagram illustrating an image processing device according to one or more example embodiments;

FIG. 9 is a block diagram specifically illustrating an operation of a neural network processor according to one or more example embodiments;

FIG. 10 is a diagram illustrating an image processing network module according to one or more example embodiments; and

FIG. 11 is a block diagram illustrating an electronic device according to one or more example embodiments.

### DETAILED DESCRIPTION

Hereinafter, example embodiments of the disclosure will be described in detail with reference to the accompanying drawings. As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

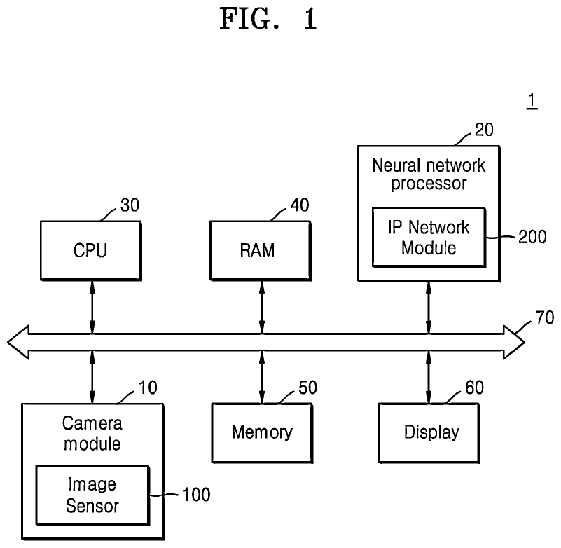

FIG. 1 is a block diagram illustrating a neural network system 1 according to one or more example embodiments.

The neural network system 1 may infer information included in input data by training (or learning) a neural network or analyzing the input data by using the neural network. The neural network system 1 may determine a situation based on the inferred information or may control components of an electronic device on which the neural network system 1 is mounted based on the inferred information. For example, the neural network system 1 may be applied to various devices such as, for example but not limited to, a smartphone, a tablet device, a smart TV, an augmented reality (AR) device, an Internet of things (IoT) device, a self-driving car, robotics, a medical device, a drone, an advanced drivers assistance system (ADAS), an image display device, and a measurement device that perform voice recognition, image recognition, image classification, and image processing by using a neural network. In addition, the neural network system 1 may be mounted in one of various types of electronic devices. In an embodiment, the neural network system 1 of FIG. 1 may be an application processor. Hereinafter, for illustrative purposes, the neural network system 1 may be described using an example in which the neural network system is applied to an image processing device to perform image processing operations on image data of a camera module (or camera) 10.

Referring to FIG. 1, the neural network system 1 may include the camera module 10, a neural network processor (or a neural network device) 20, a central processing unit (CPU) 30, a random access memory (RAM) 40, a memory 50, and a display 60. Although not shown, the neural network system 1 may further include an input/output module, a security module, and a power control device and may further include various types of processors.

In an embodiment, some or all of the components of the neural network system 1 may be formed in one semiconductor chip. For example, the neural network system 1 may be implemented as a system-on-chip (SoC), and in some embodiments, may be referred to as an image chip. The components of the neural network system 1 may communicate with one another through a bus 70.

The CPU 30 controls the overall operation of the neural network system 1.

The CPU 30 may include one processor core or a plurality of processor cores. The CPU 30 may process or execute programs and/or data stored in a storage region such as the memory 50 by using the RAM 40.

For example, the CPU 30 may execute an application and may control the neural network processor 20 to perform a neural network-based task required by execution of the application. The neural network may include a neural network model based on at least one of an artificial neural network (ANN), a convolution neural network (CNN), a region with a convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, a plain residual network, a dense network, a hierarchical pyramid network, and a fully convolutional network. In addition, a type of the neural network model is not limited thereto.

The neural network processor 20 may perform a neural network operation based on the received input data. Furthermore, the neural network processor 20 may generate an information signal based on a result of performing the neural network operation. The neural network processor 20 may be implemented as, for example but not limited to, a neural network operation accelerator, a coprocessor, a digital signal processor (DSP), an application specific integrated circuit (ASIC), a field-programmable gate array (FPGA), a graphics processing unit (GPU), a neural processing unit (NPU), a tensor processing unit (TPU), and/or a multi-processor system-on-chip (MPSoC).

The camera module 10 may capture a subject (or an object) outside the neural network system 1 and may generate image data based thereon. For example, the camera module 10 may include an image sensor 100. The image sensor 100 may convert an optical signal of the subject into an electrical signal by using an optical lens (not shown). To this end, the image sensor 100 may include a pixel array in which a plurality of pixels are two-dimensionally arranged. For example, one of a plurality of reference colors may be assigned to each of the plurality of pixels. For example, the plurality of reference colors may include red, green, and blue (RGB), or red, green, blue, and white (RGBW).

The camera module 10 may generate the image data by using the image sensor 100. The image data may be variously referred to as an image frame and frame data. The image data may be provided as input data to the neural network processor 20 or may be stored in the memory 50. The image data stored in the memory 50 may be provided to the neural network processor 20.

The neural network processor 20 according to an embodiment may receive the image data from the camera module 10 or the memory 50 and may perform the neural network operation based on the image data. The neural network processor 20 may include an image processing network module 200 defined through a neural network operation based on a predetermined neural network model. All module configurations described below may be implemented as software blocks executed by a predetermined processor, dedicated hardware blocks, or a combination thereof.

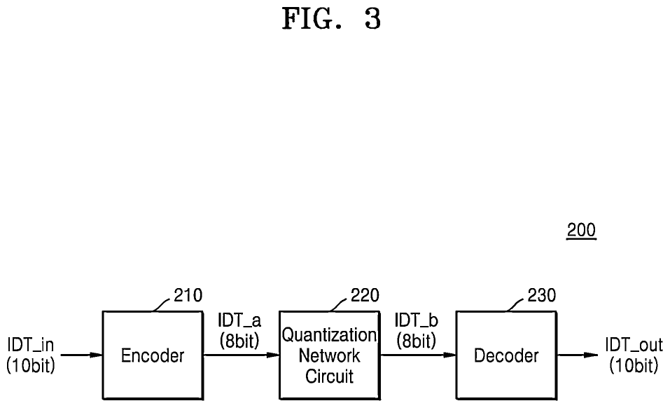

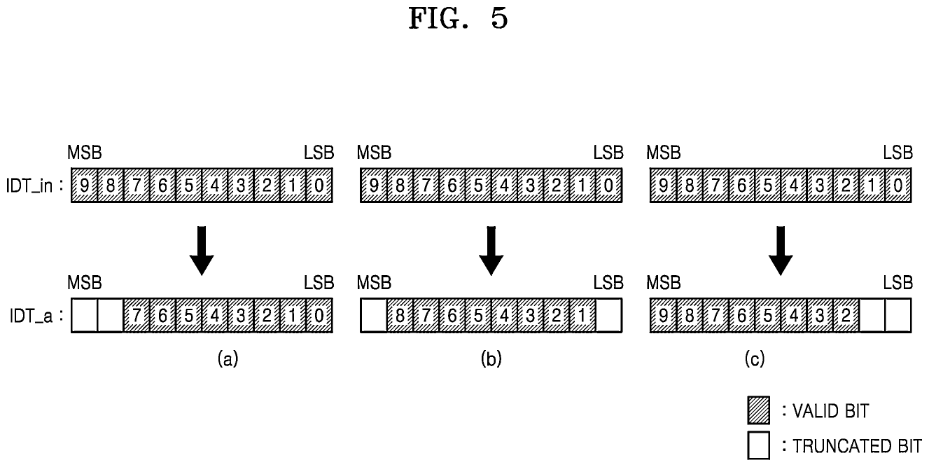

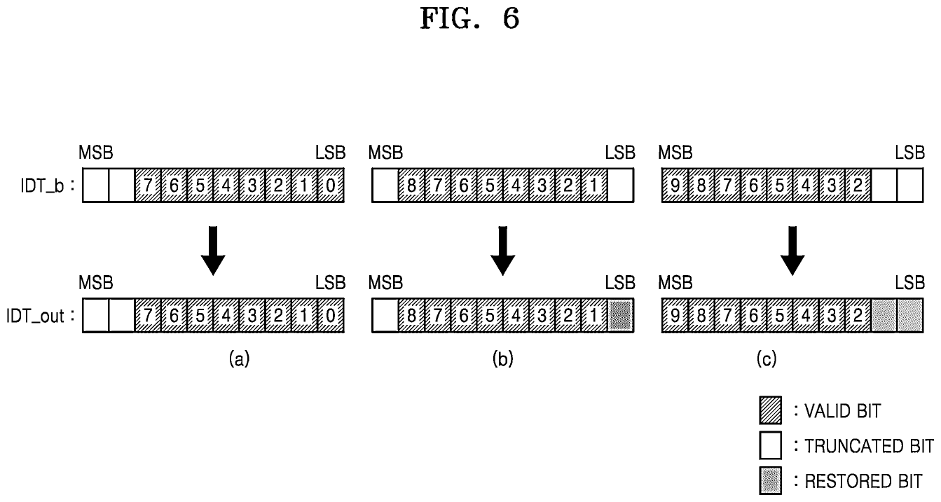

The image processing network module 200 according to an embodiment may include a neural network model trained to perform at least one of image processing operations generally performed on the image sensor 100 of the camera module 10. Here, the image processing operations may include various operations such as, for example, a bad pixel correction (BPC) operation, a lens shading correction (LSC) operation, a cross-talk correction operation, a white balance (WB) correction operation, a remosaic operation, a demosaic operation, a denoise operation, a deblur operation, a gamma correction operation, a high dynamic range (HDR) operation, and a tone mapping operation. In addition, types of the image processing operations are not limited thereto. An example of a configuration of the image processing network module 200 will be described later with reference to FIG. 3. Examples of the image processing operations performed by the image processing network module 200 will be described later with reference to FIGS. 5 and 6.

The image processing network module 200 may receive input image data generated by the image sensor 100 of the camera module 10 and may perform image processing operations on the input image data to generate output image data.

The image processing network module 200 according to an embodiment may truncate a bit depth of the input image data and may restore the truncated bit depth to generate output image data, thereby generating a high-quality image with less image quality degradation even in low light.

The memory 50 may include at least one of a volatile memory and a non-volatile memory. The non-volatile memory may include, for example but not limited to, a read only memory (ROM), a programmable ROM (PROM), an electrically programmable ROM (EPROM), an electrically erasable and programmable ROM (EEPROM), a flash memory, a phase-change random access memory (PRAM), a magnetic RAM (MRAM), a resistive RAM (RRAM), or a ferroelectric RAM (FeRAM). The volatile memory may include a dynamic RAM (DRAM), a static RAM (SRAM), a synchronous DRAM (SDRAM), a PRAM, an MRAM, an RRAM, or an FeRAM. In an embodiment, the memory 50 may include at least one of, for example but not limited to, a hard disk drive (HDD), a solid state drive (SSD), a compact flash (CF) card, a secure digital (SD) card, a micro-SD card, a mini-SD card, an extreme digital (xD) card, and a memory stick.

The display 60 may display various contents (for example, text, images, videos, icons, or symbols) to a user based on the image data received from the neural network processor 20. For example, the display 60 may include a liquid crystal display (LCD), a light-emitting diode (LED) display, an organic light-emitting diode (OLED) display, a micro-electromechanical system (MEMS) display, or an electronic paper display. The display 60 may include a pixel array in which the plurality of pixels are arranged in a matrix to display an image.

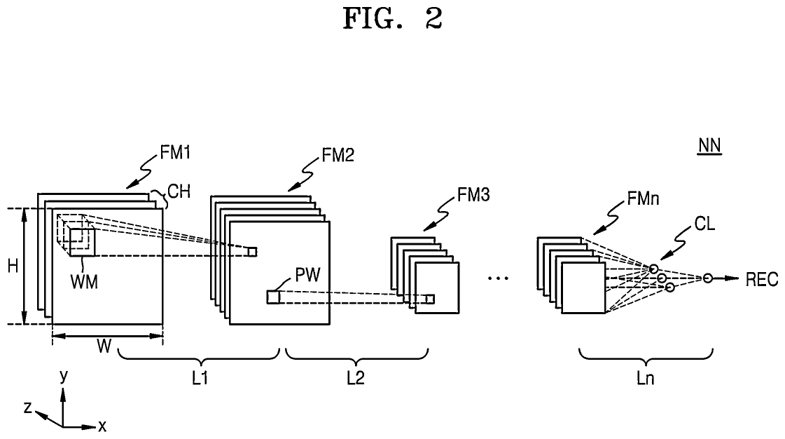

FIG. 2 is a diagram illustrating a structure of a neural network NN according to one or more example embodiments.

The structure of the neural network NN of FIG. 2 may be applied to the image processing network module 200 of FIG. 1.

Referring to FIG. 2, the neural network NN may include a plurality of layers L1 to Ln. Such a multi-layered neural network may be referred to as a deep neural network (DNN) or deep learning architecture. Each of the plurality of layers L1 to Ln may be a linear layer or a non-linear layer, and in an embodiment, at least one layer and at least one non-linear layer may be combined to be referred to as one layer. For example, the linear layer may include a convolution layer and a fully connected layer, and the non-linear layer may include a pooling layer and an activation layer.

For example, a first layer L1 may be the convolution layer, a second layer L2 may be the pooling layer, and an nth layer Ln may be the fully connected layer as an output layer. The neural network NN may further include an activation layer and layers performing different types of operations.

Each of the plurality of layers L1 to Ln may receive, as an input feature map, an input image frame or a feature map generated in a previous layer, and may perform calculation on the input feature map to generate an output feature map or a recognition signal REC. At this time, the feature map may refer to data representing various characteristics of input data. Each of feature maps FM1, FM2, FM3, . . . . FMn may have a form of, for example, a two-dimensional or three-dimensional matrix (or referred to as a tensor) including a plurality of feature values. Each of the feature maps FM1, FM2, FM3, . . . . FMn has a width W (or referred to as a column), a height H (or referred to as a row), and a depth D, which may correspond to an x-axis, a y-axis, and a z-axis on coordinates, respectively. At this time, the depth D may be referred to as a number of channels.

The first layer L1 may convolve a first feature map FM1 with a weight map WM to generate a second feature map FM2. The weight map WM may have a form of a two-dimensional or three-dimensional matrix including a plurality of weight values. The weight map WM may be referred to as a kernel. The weight map WM may filter the first feature map FM1 and may be referred to as a filter or a kernel. A depth of the weight map WM, that is, the number of channels, may be the same as the depth of the first feature map FM1, that is, the number of channels, and the same channels of the weight map WM and the first feature map FM1 may be convolved with each other. The weight map WM may be shifted in a manner of traversing the first input feature map FM1 as a sliding window. During each shift, each of weights included in the weight map WM may be multiplied and added to all feature values in an area overlapping the first feature map FM1. As the first feature map FM1 and the weight map WM are convolved, one channel of the second feature map FM2 may be generated. Although one weight map WM is illustrated in FIG. 2, in practice, a plurality of weight maps may be convolved with the first feature map FM1 to generate a plurality of channels of the second feature map FM2. In other words, the number of channels of the second feature map FM2 may correspond to the number of weight maps.

The second layer L2 may generate a third feature map FM3 by changing a spatial size of the second feature map FM2 through pooling. Pooling may be referred to as sampling or down-sampling. A two-dimensional pooling window PW may be shifted on the second feature map FM2 in a unit of a size of the pooling window PW, and a maximum value (or an average value of feature values) may be selected from among feature values of areas of the second feature map FM2 overlapping the pooling window PW. Accordingly, the third feature map FM3 of which the spatial size is changed compared to that of the second feature map FM2 may be generated from the second feature map FM2. The number of channels of the third feature map FM3 may be the same as the number of channels of the second feature map FM2.

The nth layer Ln may classify a class CL of input data by combining features of an nth feature map FMn. In addition, a recognition signal REC corresponding to the class CL may be generated.

FIG. 3 is a block diagram illustrating an image processing network module 200 according to one or more example embodiments.

The image processing network module 200 illustrated in FIG. 3 may be the same as the image processing network module 200 illustrated in FIG. 1. Hereinafter, description previously given with reference to FIG. 1 may be omitted.

Referring to FIG. 3, the image processing network module 200 may include an encoder 210, a quantization network circuit 220, and a decoder 230.

The image processing network module 200 may generate input image data IDT_in by dividing an input image into blocks of a predetermined size. The input image data IDT_in may correspond to one block unit.

The encoder 210 may change a bit depth of the input image data IDT_in. The encoder 210 may be referred to as a bit depth truncation circuit. Specifically, the encoder 210 may truncate some of bits constituting the input image data IDT_in to generate first image data IDT_a. That is, the encoder 210 may reduce an amount of image processing data by reducing the bit depth of the input image data IDT_in.

When the bit depth of the input image data IDT_in is m (m being a positive integer) bits, the encoder 210 may change the bit depth to an arbitrary n bits (n being a positive integer satisfying n<m). For example, when the input image data IDT_in has a bit depth of 10 bits, the input image data IDT_in may represent 1,024 level values from 0 to 1,023, and a high bit depth indicates that an increased amount of image data to be processed.

A quality of an image may be affected by a number of bits representing an image data value. This is because a bit depth represents a precision of image data, that is, the number of bits representing an image data value, and as a bit depth increases, data may be represented at more diverse levels.

The encoder 210 may change the bit depth of the input image data IDT_in through truncation of at least one bit among bits constituting the input image data IDT_in. The encoder 210 may truncate one or more bits of the input image data IDT_in to generate the first image data IDT_a with a changed bit depth. For example, when the input image data IDT_in has a bit depth of 10 bits, the encoder 210 may generate the first image data IDT_a having a bit depth of 8 bits. A method of the encoder 210 truncating one or more bits of the input image data IDT_in to generate the first image data IDT_a will be described later with reference to FIG. 5.

The quantization network circuit 220 may quantize the first image data IDT_a to generate second image data IDT_b. For example, the quantization network circuit 220 may quantize the first image data IDT_a generated by the encoder 210 to generate the second image data IDT_b. The quantization network circuit 220 may perform quantization based on a number of bits of the first image data IDT_a and may generate the second image data IDT_b.

Here, for example, performing quantization may mean converting a floating point-type parameter into a fixed point-type parameter. For example, the quantization network circuit 220 may perform quantization on an activation and a weight to perform a neural network operation on the first image data IDT_a. Performing quantization on an image may mean quantizing a parameter used to process a specific image into a high-resolution image.

When a neural network operation is performed to process a low-resolution image into a high-resolution image, a large amount of computations may be required. When performing a neural network operation, the quantization network circuit 220 may quantize the first image data IDT_a to generate the second image data IDT_b, thereby reducing the amount of computations and a power consumption.

The decoder 230 may change a bit depth of the second image data IDT_b. Specifically, the decoder 230 may restore bits of the second image data IDT_b to generate output image data IDT_out. The decoder 230 may be referred to as a bit depth restoration circuit. Restoring a bit may mean performing dithering to fill (or assign) a truncated bit with a bit value.

The decoder 230 may change the bit depth of the second image data IDT_b through restoration of bits constituting the second image data IDT_b. The decoder 230 may restore bits of the second image data IDT_b to generate the first image data IDT_a with a changed bit depth. A method of the decoder 230 restoring one or more bits of the second image data IDT_b to generate the output image data IDT_out will be described later with reference to FIG. 6.

When the bit depth of the second image data IDT_b is n (n being a positive integer) bits, the decoder 230 may change the bit depth to an arbitrary m (m being a positive integer satisfying n<m) bits. In addition, the decoder 230 may generate the output image data IDT_out in which n bits may be maintained.

For example, when the second image data IDT_b has a bit depth of 8 bits, the decoder 230 may restore the bit depth of the second image data IDT_b to generate the output image data IDT_out having a bit depth of 10 bits. In addition, when the second image data IDT_b has a bit depth of 8 bits, the decoder 230 may generate the output image data IDT_out maintaining a bit depth of 8 bits.

Accordingly, the image processing network module 200 according to an embodiment may reduce a bit depth for only a portion of bits selected from bits constituting an image data to reduce the amount of data processed while maintaining image characteristics of the input image data IDT_in as much as possible. Accordingly, an area and a power consumption of the image processing network module 200 may be reduced.

The image processing network module 200 according to an embodiment may truncate a bit depth of the input image data IDT_in and may restore the truncated bit depth to generate the output image data IDT_out, thereby generating a high-quality image with less image quality degradation even in low light.

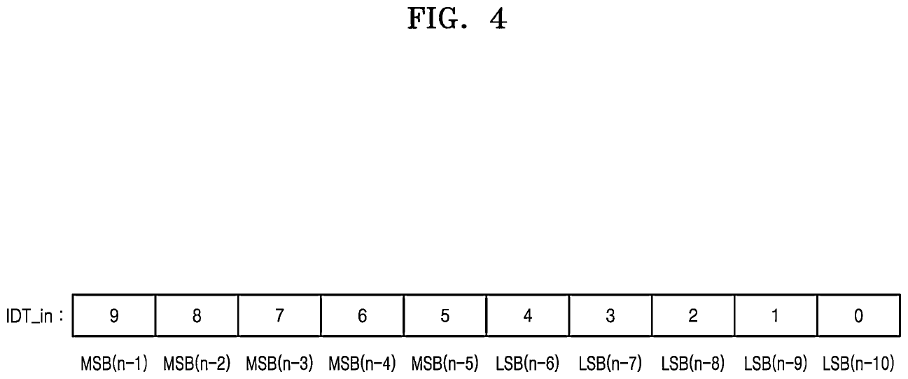

FIG. 4 is a diagram illustrating input image data IDT_in according to one or more example embodiments.

Referring to FIG. 4, the input image data IDT_in may be 10-bit data. Hereinafter, in an embodiment, description will be given assuming that the input image data IDT_in has 10 bits (that is, when the input image data has n bits and n is 10).

The input image data IDT_in may include a first most significant bit (MSB) 9, a second MSB 8, a third MSB 7, a fourth MSB 6, a fifth MSB 5, a fifth least significant bit (LSB) 4, a fourth LSB 3, a third LSB 2, a second LSB 1, and a first LSB 0. Each of the first MSB 9, the second MSB 8, the third MSB 7, the fourth MSB 6, the fifth MSB 5, the fifth LSB 4, the fourth LSB 3, the third LSB 2, the second LSB 1, and the first LSB 0 may have a value of 0 or 1. The input image data IDT_in may represent 1,024 level values from 0 to 1,023.

According to an embodiment, the input image data IDT_in may have a bit depth of 10 bits. The encoder 210 may truncate bits of the input image data IDT_in to generate the first image data IDT_a having a bit depth of 8 bits. The decoder 230 may restore one or more bits of the first image data IDT_a to generate the second image data IDT_b having a bit depth of 8 bits or more.

FIG. 5 is a diagram illustrating a bit truncating method according to one or more example embodiments.

Specifically, the bit truncating method illustrated in FIG. 5 relates to a method of the encoder 210 illustrated in FIG. 3 truncating the bits of the input image data IDT_in to generate the first image data IDT_a with a changed bit depth.

According to an embodiment, the input image data IDT_in may be 10 bits, and the first image data IDT_a may be 8 bits.

The encoder 210 may compare the input image data IDT_in with a preset maximum value and may truncate some bits of the input image data IDT_in based on a result of comparison, to generate the first image data IDT_a. Comparing the input image data IDT_in with the maximum value may mean comparing the first MSB 9 and the second MSB 8 of the input image data IDT_in with the maximum value to determine whether a level of the input image data IDT_in is less than the maximum value. That is, the encoder 210 may compare the first MSB 9 and the second MSB 8 of the input image data IDT_in with the maximum value and may truncate some bits of the input image data IDT_in to generate the first image data IDT_a.

According to an embodiment, the encoder 210 may compare the first MSB 9 and the second MSB 8 of the input image data IDT_in with the maximum value and may truncate two bits of the input image data IDT_in to generate the first image data IDT_a.

Referring to FIG. 5(a), when the maximum value is 256, based on a result of comparison of the level of the input image data IDT_in with the maximum value of 256, the first MSB 9 and the second MSB 8 of the input image data IDT_in may be truncated to generate the first image data IDT_a with the changed bit depth. That is, when the level of the input image data IDT_in is less than the maximum value of 256, the encoder 210 may truncate the first MSB 9 and the second MSB 8 of the input image data IDT_in to generate the first image data IDT_a having a bit depth of 8 bits.

Referring to FIG. 5(b), when the maximum value is 512, based on a result of comparison of the level of the input image data IDT_in with the maximum value of 512, the first MSB 9 and the first LSB 0 of the input image data IDT_in may be truncated to generate the first image data IDT_a with the changed bit depth. When the level of the input image data IDT_in is less than the maximum value of 512 and equal to or greater than 256, the encoder 210 may truncate the first MSB 9 and the first LSB 0 of the input image data IDT_in to generate the first image data IDT_a having a bit depth of 8 bits.

Referring to FIG. 5(c), when the maximum value is 1,024, based on a result of comparison of the level of the input image data IDT_in with the maximum value of 1,024, the first LSB 0 and the second LSB 1 of the input image data IDT_in may be truncated to generate the first image data IDT_a with the changed bit depth. When the level of the input image data IDT_in is less than the maximum value of 1,024 and equal to or greater than 512, the encoder 210 may truncate the first LSB 0 and the second LSB 1 of the input image data IDT_in to generate the first image data IDT_a having a bit depth of 8 bits.

According to an embodiment, the encoder 210 may truncate two bits from an MSB to an LSB among the bits of the input image data IDT_in to change the bit depth.

FIG. 6 is a diagram illustrating a bit restoring method according to one or more example embodiments.

Specifically, the bit restoring method illustrated in FIG. 6 relates to a method of the encoder 210 illustrated in FIG. 3 restoring the bits of the second image data IDT_b to generate the output image data IDT_out with a changed bit depth.

According to an embodiment, the second image data IDT_b may be 8 bits, and the output image data IDT_out may be 10 bits.

The decoder 230 may restore one or more bits of the second image data IDT_b to generate the output image data IDT_out. For example, restoring one or more bits of the second image data IDT_b may mean generating 10-bit output image data IDT_out from 8-bit data. That is, the decoder 230 may restore the bits of the second image data IDT_b to generate the output image data IDT_out.

According to an embodiment, the decoder 230 may restore the bits of the second image data IDT_b to generate the output image data IDT_out.

Referring to FIG. 6(a), when the maximum value is 256, based on a result of comparison between a level of the output image data IDT_out and the maximum value of 256, the output image data IDT_out may be generated without restoring the first MSB 9 and the second MSB 8 of the second image data IDT_b. That is, when the level of the second image data IDT_b is less than the maximum value of 256, the decoder 230 may generate the output image data IDT_out having a bit depth of 8 bits without restoring the first MSB 9 and the second MSB 8 of the second image data IDT_b.

Referring to FIG. 6(b), when the maximum value is 512, based on a result of comparison between a level of the output image data IDT_out and the maximum value of 512, the output image data IDT_out with the changed bit depth may be generated by restoring the first LSB 0 of the second image data IDT_b. When the level of the second image data IDT_b is less than the maximum value of 512, the decoder 230 may restore the first LSB 0 of the second image data IDT_b to generate the output image data IDT_out having a bit depth of 9 bits.

Referring to FIG. 6(c), when the maximum value is 1,024, based on a result of comparison between a level of the output image data IDT_out and the maximum value of 1,024, the first LSB 0 and the second LSB 1 of the second image data IDT_b may be restored to generate the output image data IDT_out with the changed bit depth. When the level of the second image data IDT_b is less than the maximum value of 1,024, the decoder 230 may restore the first LSB 0 and the second LSB 1 of the second image data IDT_b to generate the output image data IDT_out having a bit depth of 10 bits.

According to an embodiment, the decoder 230 may restore one or more bits from an LSB to an MSB among the bits of the second image data IDT_b to change the bit depth.

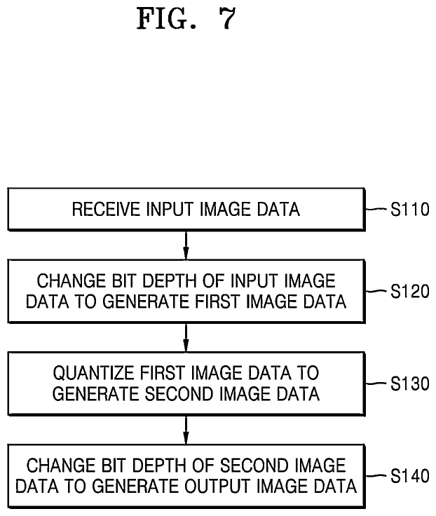

FIG. 7 is a flowchart illustrating a method of operating an image processing network module 200 according to one or more example embodiments.

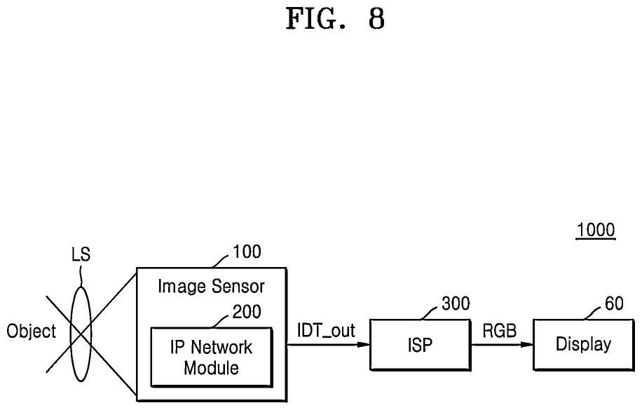

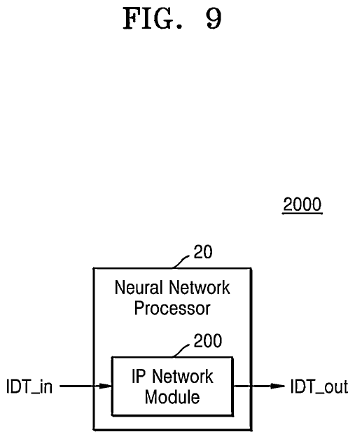

Specifically, FIG. 7 is a flowchart illustrating a method of operating the image processing network module 200 described above with reference to FIG. 3. Although the method of operating the image processing network module 200 will be described below for convenience of description, the method may be applied to an image processing device 1000 and an image processing device 2000 to be described later with reference to FIGS. 8 and 9.

Referring to FIG. 7, the image processing network module 200 may receive the input image data IDT_in in operation S110. For example, referring to FIG. 3, the encoder 210 may receive the input image data IDT_in obtained by dividing the input image into blocks of a predetermined size. The input image data IDT_in may be in one block unit, and the input image data IDT_in may be data having a bit depth of 10 bits, for example.

The image processing network module 200 may change the bit depth of the input image data IDT_in to generate the first image data IDT_a in operation S120. For example, referring to FIG. 3, the encoder 210 may truncate one or more bits among bits constituting the input image data IDT_in to generate the first image data IDT_a.

The image processing network module 200 may quantize the first image data IDT_a to generate the second image data IDT_b in operation S230. For example, referring to FIG. 3, the quantization network circuit 220 may quantize the first image data IDT_a to generate the second image data IDT_b.

The image processing network module 200 may change the bit depth of the second image data IDT_b to generate the output image data IDT_out. For example, referring to FIG. 3, the decoder 230 may restore one or more bits of the second image data IDT_b to generate the output image data IDT_out.

Accordingly, in a method of operating the image processing network module 200 according to an embodiment, a bit depth may be reduced for one or more bits selected from bits constituting an image, thereby reducing the amount of data processed while maintaining image characteristics of the input image data IDT_in as much as possible. Accordingly, a power consumption may be reduced in the method of operating the image processing network module.

In addition, in the method of operating the image processing network module according to an embodiment, the bit depth of the input image data IDT_in may be truncated and the truncated bit depth may be restored to generate the output image data IDT_out, thereby generating a high-quality image with less image quality degradation even in low light.

FIG. 8 is a block diagram illustrating an image processing device 1000 according to one or more example embodiments.

The image sensor 100 illustrated in FIG. 8 may correspond to the image sensor 100 illustrated in FIG. 1, and the image processing network module 200 illustrated in FIG. 8 may correspond to the image processing network module 200 illustrated in FIGS. 1 and 3. Hereinafter, description previously given with reference to FIGS. 1 and 3 may be omitted.

Referring to FIG. 8, the image processing device 1000 may include an optical lens LS, an image sensor 100, an image signal processor 300, and a display 60. The image sensor 100 may include the image processing network module 200.

In addition, the image processing device 1000 may further include other general-purpose components such as a memory, a communication module, a video module (for example, a camera interface, a joint photographic experts group (JPEG) processor, a video processor, or a mixer), a 3D graphics core, an audio system, a display driver, a GPU, and a DSP.

When the output image data IDT_out generated by the image sensor 100 needs to be displayed on the display 60, the image signal processor 300 may convert the output image data IDT_out into a data format suitable for the display 60, such as RGB data. The display 60 may display RGB data RGB received from the image signal processor 300.

In addition, the image processing network module 200 may truncate the bit depth of the input image data and may restore the truncated bit depth to generate the output image data IDT_out. Accordingly, the amount of image data processed by the image processing network module 200 may be reduced and a power consumption may be reduced.

FIG. 9 is a block diagram illustrating an operation of a neural network processor 20 according to one or more example embodiments.

Referring to FIG. 9, an image processing device 2000 may include the neural network processor 20. The neural network processor 20 may include an image processing network module 200. That is, the image processing network module 200 may be a neural network model trained to perform image processing operations on the input image data IDT_in to output the output image data IDT_out. Accordingly, the neural network processor 20 may perform the operation of the image processing network module 200 illustrated in FIGS. 1 and 3.

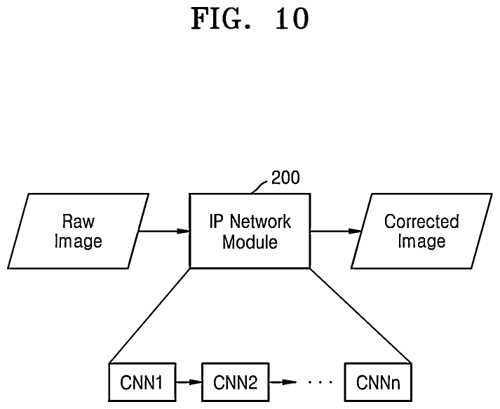

FIG. 10 is a diagram illustrating an image processing network module 200 according to one or more example embodiments.

Specifically, FIG. 10 is a diagram illustrating the image processing network module 200 of FIG. 1. The description of FIG. 10 may be equally applied to the image processing network module 200 illustrated in FIGS. 1 and 3.

Referring to FIG. 10, the image processing network module 200 may perform a preset image processing operation on a raw image as input image data and may generate output image data that is a corrected image as a result of performing the preset image processing operation.

According to an embodiment, the image processing network module 100 may be trained to perform, for example, a remosaic operation, a demosaic operation, a denoising operation, and a deblurring operation while processing distortion in the raw image.

In some embodiments, the image processing network module 200 may perform learning by using not only the raw image but also additional information as the input image data. For example, the image processing network module 200 may perform learning to generate the output image data that is the corrected image by using the raw image, bad pixel information, and noise level measurement information as the input image data.

In some embodiments, the image processing network module 200 may include a plurality of neural network modules CNN1, CNN2, . . . , and CNNn. For example, the image processing network module 200 may include the plurality of neural network modules CNN1, CNN2, . . . , and CNNn corresponding to a plurality of image processing operations or a combination of the plurality of image processing operations. Although it is illustrated in FIG. 6 that the plurality of neural network modules CNN1, CNN2, . . . , and CNNn are CNN models, this is only one example embodiment and the disclosure is not limited thereto. For example, the image processing network module 200 may be implemented to include a plurality of CNN models and ANN models.

In some embodiments, the image processing network module 200 may be learned in advance by the manufacturer and provided when manufacturing the image processing device. In some embodiments, the image processing network module 200 learned based on the raw image and the corrected image collected from a plurality of image processing devices by the manufacturer may be provided when manufacturing the image processing device.

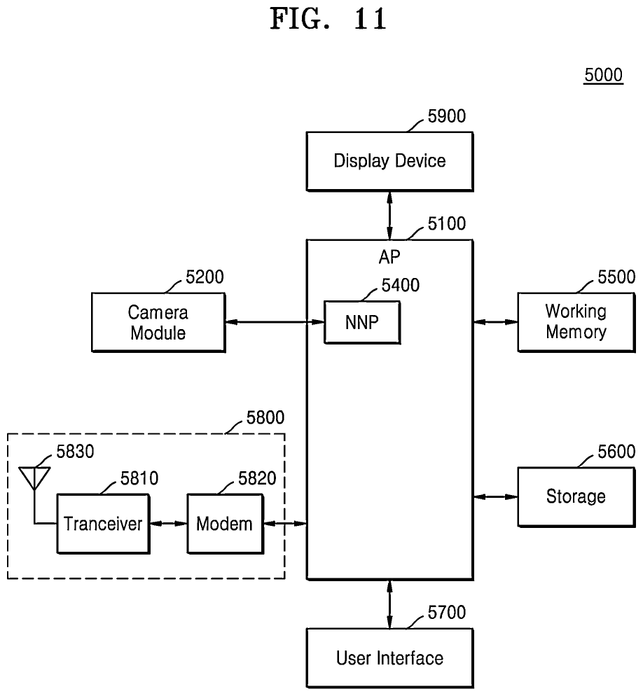

FIG. 11 is a block diagram illustrating an electronic device 5000 according to one or more example embodiments. The electronic device 5000 illustrated in FIG. 11 may be a portable terminal.

Referring to FIG. 11, the electronic device 5000 according to an embodiment may include an application processor 5100, a camera module (e.g., a camera) 5200, a working memory 5500, a storage 5600, a user interface 5700, a wireless transceiver 5800, and a display device 5900.

The application processor 5100 may include a neural network processor 5400. The image processing operation according to one or more embodiments described with reference to FIG. 1 may be applied to the neural network processor 5400. In an embodiment, the neural network processor 5400 may be implemented as an integrated circuit separate from the application processor 5100.

The application processor 5100 may control the overall operation of the electronic device 5000 and may be provided as an SoC for driving an application program and an operating system. The application processor 5100 may control an operation of the neural network processor 5400, and may provide or store converted image data generated by the neural network processor 5400 to the display device 5900 or in the storage 5600.

The camera module 5200 may generate image data, for example, raw image data based on a received optical signal and may provide the image data to the neural network processor 5400.

The working memory 5500 may be implemented as volatile memory such as a DRAM or a static random-access memory (SRAM) or a non-volatile resistive memory such as an FeRAM, an RRAM, or a PRAM. The working memory 5500 may store programs and/or data processed or executed by the application processor 5100.

The storage 5600 may be implemented as a non-volatile memory device such as a NAND flash or a resistive memory. For example, the storage 5600 may be provided as a memory card such as, for example, a multimedia card (MMC), an embedded MMC (eMMC), a secure digital (SD) card, or a micro-SD card. The storage 5600 may store data and/or programs for an execution algorithm that controls an image processing operation of the neural network processor 5400, and when the image processing operation is performed, data and/or programs may be loaded to the working memory 5500. In an embodiment, the storage 5600 may store image data generated by the neural network processor 5400, for example, converted image data or post-processed image data.

The user interface 5700 may be implemented as various devices capable of receiving a user input such as, for example, a keyboard, a curtain key panel, a touch panel, a fingerprint sensor, and a microphone. The user interface 5700 may receive a user input and may provide a signal corresponding to the received user input to the application processor 5100. The wireless transceiver 5800 may include a transceiver 5810, a modem 5820, and an antenna 5830.

While the disclosure has been particularly shown and described with reference to example embodiments thereof, it will be understood that various changes in form and details may be made therein without departing from the spirit and scope of the following claims and their equivalents.

What is claimed is:

1. An image processing network module comprising:
an encoder configured to receive input image data and change a bit depth of the input image data to generate first image data;
a quantization network configured to quantize the first image data to generate second image data; and
a decoder configured to receive the second image data and change a bit depth of the second image data to generate output image data.

2. The image processing network module of claim 1, wherein the input image data comprises m-bit data,
wherein each of the first image data and the second image data comprises n-bit data, and
wherein m and n are positive integers and n is less than m.

3. The image processing network module of claim 1, wherein the output image data is m-bit data or n-bit data, and
wherein m and n are positive integers and n is less than m.

4. The image processing network module of claim 1, wherein the encoder is configured to truncate at least one bit of the input image data to change the bit depth of the input image data.

5. The image processing network module of claim 4, wherein the encoder is configured to compare a first most significant bit (MSB) and a second MSB of the input image data with a preset maximum value, and truncate the at least one bit of the input image data based on a result of comparison.

6. The image processing network module of claim 4, wherein the encoder is configured to truncate at least two bits of the input image data.

7. The image processing network module of claim 1, wherein the decoder is configured to change the bit depth of the second image data by restoring at least one bit of the second image data.

8. The image processing network module of claim 7, wherein the decoder is configured to restore the at least one bit of the second image data from a least significant bit (LSB) of the second image data to a most significant bit (MSB) of the second image data.

9. The image processing network module of claim 1, wherein the image processing network module is configured to perform image processing on the input image data by using a neural network model trained to perform preset image processing operations to generate the output image data.

10. The image processing network module of claim 9, wherein the neural network model is trained to perform at least one of a remosaic operation, a super-resolution operation, and a deblurring operation.

11. An image processing device comprising:
a camera configured to receive an input image; and
a neural network processor configured to generate input image data by dividing the input image into blocks of a predetermined size and configured to generate output image data by performing image processing on the input image data by using a neural network model trained to perform preset image processing operations, wherein the neural network processor comprises:
an encoder configured to receive the input image data and change a bit depth of the input image data to generate first image data;
a quantization network configured to quantize the first image data to generate second image data; and
a decoder configured to receive the second image data and change a bit depth of the second image data to generate the output image data.

12. The image processing device of claim 11, wherein the neural network model is trained to perform at least one of a remosaic operation, a super-resolution operation, and a deblurring operation.

13. The image processing device of claim 11, wherein the input image data is m-bit data,
wherein each of the first image data and the second image data is n-bit data, and
wherein n and m are positive integers, and n is less than m.

14. The image processing device of claim 11, wherein the encoder is configured to truncate at least one bit of the input image data to change the bit depth of the input image data, and
wherein the decoder is configured to restore at least one bit of the second image data to change the bit depth of the second image data.

15. The image processing device of claim 14, wherein a first most significant bit (MSB) and a second MSB of the input image data are compared with a preset maximum value and truncate at least two bits of the input image data.

16. The image processing device of claim 14, wherein the decoder is configured to generate the output image data by restoring a least significant bit (LSB) of the second image data.

17. The image processing device of claim 11, further comprising a display configured to display an image based on the output image data.

18. A method of operating an image processing device, the method comprising:
receiving an input image;
dividing the input image into blocks of a predetermined size to generate input image data;
generating first image data by changing a bit depth of the input image data;
quantizing the first image data to generate second image data; and
generating output image data by changing a bit depth of the second image data.

19. The method of claim 18, wherein the generating the first image data comprises comparing a first most significant bit (MSB) and a second MSB of the input image data with a preset maximum value to truncate at least two bits of the input image data, and
wherein the generating the output image data comprises restoring an LSB of the second image data.

20. The method of claim 19, wherein the input image data is m-bit data, wherein each of the first image data and the second image data is n-bit data, and wherein n and m are positive integers, and n is less than m.
